(19) United States
(12) Patent Application Publication
(10) Pub. No.: US 2020/0147694 A1
(43) Pub. Date: May 14, 2020

(54) METHOD FOR MANUFACTURING A POLYCRYSTALLINE SUPERHARD CUTTER UTILIZING LEACHING PASSAGES

(71) Applicant: VAREL INTERNATIONAL IND., L.L.C., Carrollton, TX (US)

(72) Inventor: FEDERICO BELLIN, Tomball, TX (US)

(21) Appl. No.: 16/575,345

(22) Filed: Sep. 18, 2019

Related U.S. Application Data
(60) Provisional application No. 62/757,547, filed on Nov. 8, 2018.

(51) Int. Cl. B22F 3/24; B22F 3/02; B22F 5/00; B23B 27/16

(52) U.S. Cl. CPC B22F 3/24; B22F 3/02; B22F 5/00; B23B 2226/315; B22F 2003/244; B22F 2005/001; B22F 2302/406; B23B 27/16

(57) ABSTRACT

A method for manufacturing a cutter includes: boring a passage into a polycrystalline superhard cutting head, the passage extending from a front face of the cutting head toward a side thereof; and introducing acid into the passage, thereby removing at least a portion of a metal from the cutting head.

### BACKGROUND OF THE DISCLOSURE

### Field of the Disclosure

The present disclosure generally relates to a method for manufacturing a polycrystalline superhard cutter utilizing leaching passages.

### Description of the Related Art

U.S. Pat. No. 8,932,377 discloses a system for producing thermally stable cutting elements including a heat source, a pressure vessel, at least one polycrystalline diamond body attached to a carbide substrate, and a leaching agent is disclosed, wherein the heat source includes a container comprising at least one receiving mechanism and at least one retention mechanism, and wherein the carbide substrate is disposed in the at least one receiving mechanism of the pressure vessel, and wherein the leaching agent is disposed in the pressure vessel, and wherein the leaching agent removes the catalyzing material from the interstitial spaces interposed between the diamond particles of the at least one polycrystalline diamond body, and wherein the at least one retention mechanism of the pressure vessel seals at least a portion of the carbide substrate into the at least one receiving mechanism and prevents the leaching agent from contacting at least a portion of the carbide substrate.

U.S. Pat. No. 9,175,521 discloses a cutting table including a cutting surface, an opposing surface, a cutting table outer wall, and one or more slots. The cutting table outer wall extends from the circumference of the opposing surface to the circumference of the cutting surface. The slots extend from a portion of the cutting surface to a portion of the cutting table outer wall. The cutting table is leached to form a thermally stable cutting table. One or more slots are positioned in parallel with at least another slot in some embodiments. In some embodiments, the slots are positioned circumferentially around the cutting surface. In some embodiments, at least one slot is backfilled with a backfilling material to increase heat transfer or impact resistance. In some embodiments, the cutting table is coupled to a substrate to form a cutter. The slots are formed either after or during the formation of the cutting table.

US 2018/0313163 discloses a cutting table including hard material, and a fluid flow pathway within the hard material. The fluid flow pathway is configured to direct fluid proximate outermost boundaries of the hard material through one or more regions of the hard material inward of the outermost boundary of the hard material. A cutting element and an earth-boring tool are also described.

WO 2018/050796 discloses a method for manufacturing an impregnated segment includes forming a base tier by depositing one or more layers of molten metallic material. The base tier has a plurality of cavities. The method further includes inserting at least one superhard particle into each cavity and forming an additional tier on top of the base tier by depositing one or more layers of the molten metallic material. The additional tier has a plurality of cavities. The method further includes repeating the insertion of the superhard particles and the formation of additional tiers to form an impregnated cage.

### SUMMARY OF THE DISCLOSURE

The present disclosure generally relates to a method for manufacturing a polycrystalline superhard cutter utilizing leaching passages. In one embodiment, a method for manufacturing a cutter includes: boring a passage into a polycrystalline superhard cutting head, the passage extending from a front face of the cutting head toward a side thereof; and introducing acid into the passage, thereby removing at least a portion of a metal from the cutting head.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A illustrates cutting table powder loaded into an inner can for a high pressure and high temperature (HPHT) sintering operation. FIG. 1B illustrates a substrate loaded into the inner can and placement of an outer can. FIG. 1C illustrates the HPHT sintering operation to form a superhard cutter. FIG. 1D illustrates grinding of the superhard cutter.

FIGS. 2A and 2B illustrate laser cutting the leaching passages.

FIG. 3 illustrates the cutting table of the superhard cutter.

FIG. 4 illustrate leaching of the cutting table.

FIG. 5A illustrates the leached superhard cutter. FIG. 5B illustrates brazing of the leached cutter into a blade of a drill bit.

### DETAILED DESCRIPTION

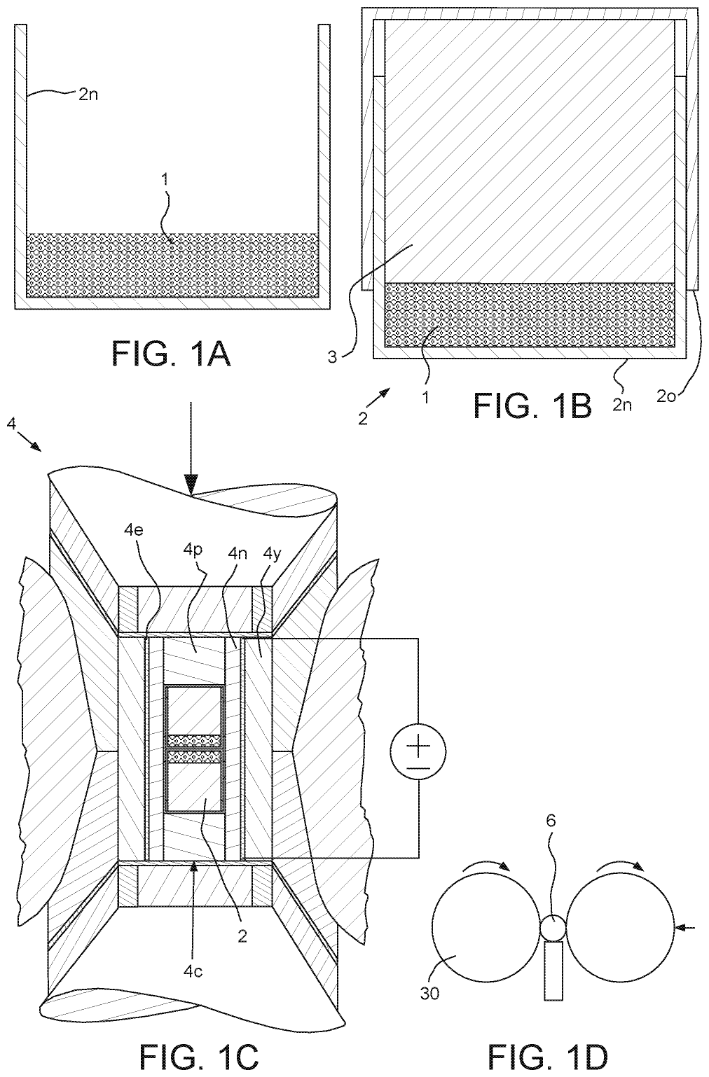

FIG. 1A illustrates cutting table powder 1 loaded into an inner can 2n for a high pressure and high temperature (HPHT) sintering operation. The inner can 2n may be made from a refractory metal and may have a cylindrical cavity formed therein for receiving the cutting table powder 1. The cutting table powder 1 may be monocrystalline synthetic diamond. A quantity of the cutting table powder 1 may be poured into the inner can 2n. During or after pouring of the cutting table powder 1, the inner can 2n may be vibrated to compact the cutting table powder.

Alternatively, the cutting table powder 1 may be another superhard material powder, such as cubic boron nitride powder, instead of the diamond powder.

FIG. 1B illustrates a substrate 3 loaded into the inner can 2n and placement of an outer can 20. The substrate 3 may be cylindrical and pre-fabricated by a sintering operation, such as hot isotactic pressing. The substrate 3 may be fabricated from a hard material, such as a cermet. The cermet may be a cemented carbide, such as a group 8-10 metal-tungsten carbide. The group 8-10 metal may be cobalt. The substrate 3 may be inserted into the cavity of the inner can 2n and into engagement with the cutting table powder 1 while a back portion of the substrate may protrude from an end of the inner can 2n. The outer can 20 may then placed over the inner can 2n. The outer can 20 may be made from a refractory metal and may have a cylindrical cavity formed therein for receiving the inner can 2n and the back portion of the substrate 3. The loaded cans 2n,o may then be sealed, thereby forming a can assembly 2.

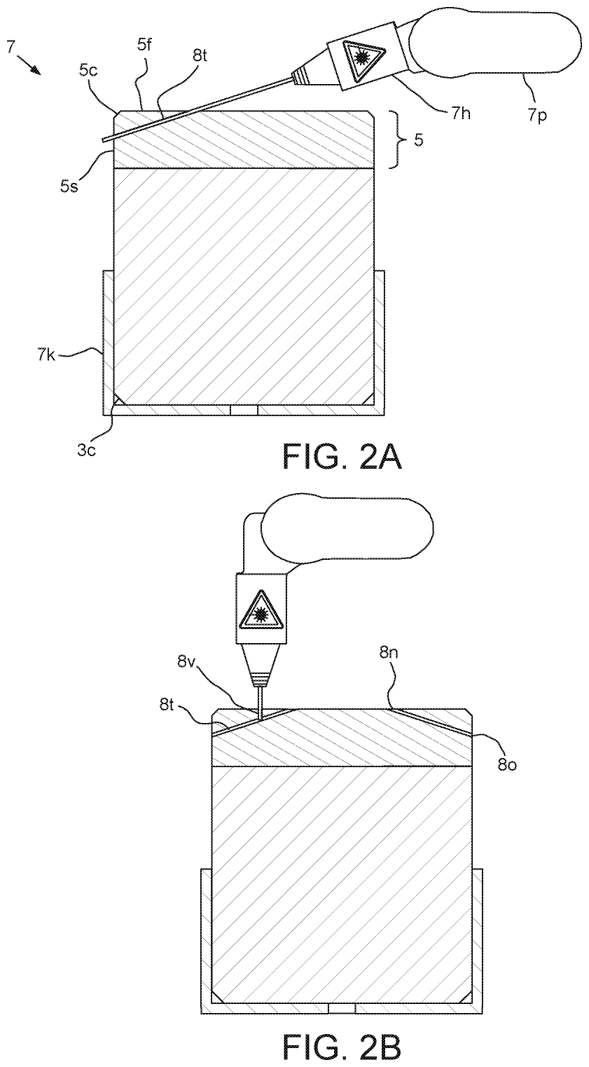

FIG. 1C illustrates the HPHT sintering operation to form a superhard cutter 6 (FIG. 1D). A plurality of can assemblies 2 may be assembled with a liner 4n, a heating element 4e, a pair of plugs 4p, and a cylinder 4y to form a cell 4c. The cell 4c may then be inserted into a HPHT press, such as a belt press 4, and the belt press operated to perform the HPHT sintering operation, thereby causing the metal component of the substrate 3 to melt and sweep into the cutting table powder 1. The molten metal may act as a catalyst for recrystallization of the superhard monocrystalline diamond into polycrystalline diamond (PCD), thereby forming a coherent cutting table 5 (FIG. 2A), while bonding the cutting table and substrate 3 together to form the superhard cutter 6. A temperature of the HPHT sintering operation may range between fourteen hundred and eighteen hundred degrees Celsius and a pressure thereof may range between four and ten gigaPascals.

Alternatively, a cubic press may be used to perform the HPHT sintering operation instead of the belt press 4. Alternatively, the inner can 2n may have a nonplanar bottom for forming a shaped cutting head instead of the planar cutting head, such as the cutting table 5.

FIG. 1D illustrates grinding of the superhard cutter 6. The cutter 6 may be removed from the cell 4c and inserted into a cylindrical grinder 30 and/or other finishing machines to remove excess material, polish surfaces thereof, and form a chamfer 5c (FIG. 2A) into a periphery of the cutting table 5 at a front face 5f (FIG. 2A) thereof distal from the substrate 3 and a chamfer 3c (FIG. 2A) into a periphery of the substrate 3 at the back end thereof.

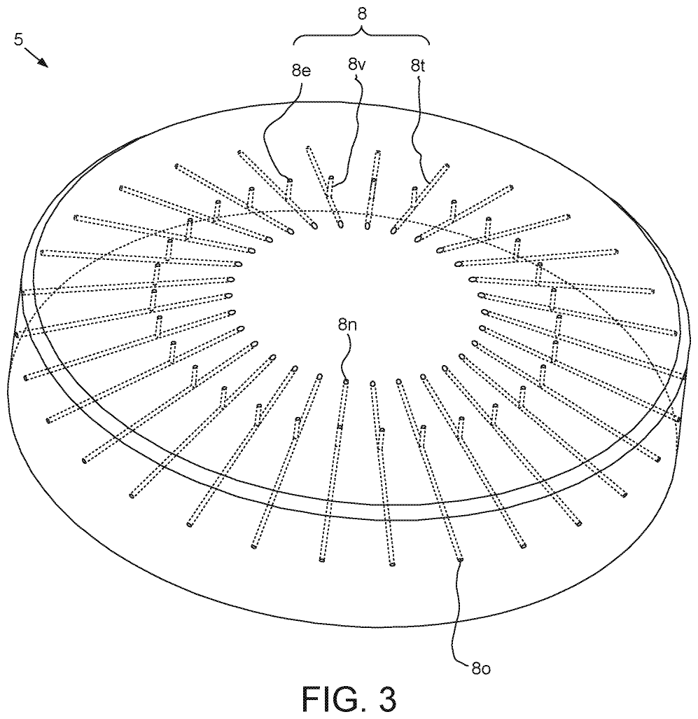

FIGS. 2A and 2B illustrate laser cutting the leaching passages 8. FIG. 3 illustrates the cutting table 5 of the superhard cutter 6. The superhard cutter 6 may removed from the grinder 30 and loaded into a chuck 7k of a laser cutter machine 7. The laser cutting machine 7 may include a controller (not shown), such as a programmable logic controller. A computer-aided manufacturing (CAM) model of the cutting table 5 with the leaching passages 8 may be uploaded thereto. The controller may be in communication with a drive motor (not shown) of the chuck 7k, a positioner 7p, and a head 7h of the laser cutting machine 7. The head 7h of the laser cutter machine 7 may be positioned and operated by the controller to bore a root leaching passage 8t from the front face 5f of the cutting table 5 to a side 5s thereof. Once the root leaching passage 8t has been formed, the controller may operate the chuck motor to rotate the chuck 7k by an increment and the head 7h to bore a second root passage. This process may be repeated until a plurality of root passages 8t are spaced around the cutting table 5 at the increment, such as at least eight passages spaced at a forty-five degree increment. The increment may be equal to three hundred sixty degrees divided by the number of root passages 8t.

Each root passage 8t may have an inlet 8n (or first end) at the front face 5f of the cutting table 5 and an outlet 8o (or second end) at the side 5s thereof and behind the chamfer 5c. Each root passage 8t may extend outward and backward from the inlet 8n to the outlet 80. Each inlet 8n may be spaced from the side 5s of the cutting table 5 by a distance ranging between twenty percent and forty percent of a diameter of the cutting table. Each outlet 8o may be spaced from the front face 5f of the cutting table 5 by a distance ranging between ten percent and sixty percent of a thickness of the cutting table. An inclination angle of each root passage 8t relative to the front face 5f may range between five degrees and forty-five degrees.

Once all the root passages 8t have been formed, the controller may reposition and operate the head 7h to bore a riser leaching passage 8v from the front face 5f of the cutting table to one of the root passages 8t. Once the riser leaching passage 8v has been formed, the controller may operate the chuck motor to rotate the chuck 7k by the increment and the head 7h to bore a second riser passage 8v. This process may be repeated until a riser passage 8v has been formed for each root passage 8t. Each riser passage 8v may have an inlet 8e (or end) at the front face 5f of the cutting table 5 and may extend straight to the respective root passage 8t, thereby forming a junction therewith. Each inlet 8e may be outward of the respective inlet 8n of the root passage 8t and may be spaced from the side 5s of the cutting table 5 by a distance ranging between ten percent and thirty percent of the diameter of the cutting table.

A diameter of each leaching passage 8 may range between one hundredth of a millimeter and one millimeter. The diameter of each leaching passage 8 may be constant and equal or the diameter of each root passage 8t may be greater at the inlet 8n thereof than at the outlet 8o thereof. If the diameter of each root passage 8t varies, then the diameter of each riser passage 8v may be equal to the diameter of the respective root passage at the inlet 8n thereof.

Alternatively, the leaching passages 8 may be formed by using an electrical discharge machine (EDM) instead of the laser cutting machine 7.

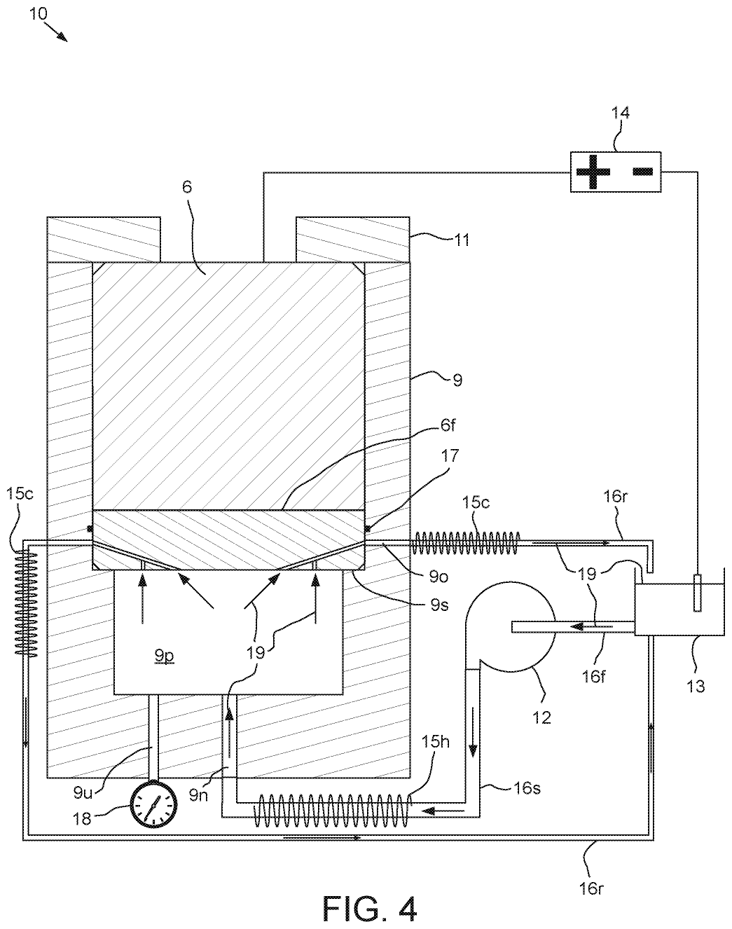

FIG. 4 illustrates leaching of the cutting table 5. Once all the leaching passages 8 have been formed in the cutting table 5, the cutter 6 may be removed from the chuck 7k and inserted into a receptacle 9 of a leaching system 10. The leaching system 10 may include the receptacle 9, a clamp 11, a pump 12, a reservoir 13, a power supply 14, a heater/cooler 15c,h, and one or more flowlines, such as a supply line 16s, a feed line 16f, and a pair of return lines 16r.

The receptacle 9 may include a cutter chamber for receiving the cutter 6, a plenum 9p, and a shoulder 9s formed therebetween for seating an outer portion of the front face 5f. The receptacle 9 may be made with or lined with an acid-resistant material, such as a ceramic or polymer. The receptacle 9 may have a seal groove formed in a side thereof adjacent to the cutter chamber and a seal 17 may be disposed in the seal groove. The seal 17 may engage the side 5s of the cutting table 5 adjacent to an interface 6f with the substrate 3 for isolating the interface and the substrate from the leaching process. The receptacle 9 may have an inlet port 9n formed through a bottom thereof in fluid communication with the plenum and one or more (pair shown) outlet ports 90 formed through a side thereof between the shoulder 9s and the seal groove. The receptacle 9 may also have a pressure port 9u formed through the bottom thereof and a pressure sensor 18 may be in fluid communication with the pressure port. The clamp 11 may be fastened to a top of the receptacle 9 and engaged with the back face of the substrate 3, thereby trapping the cutter 6 in the cutter chamber of the receptacle.

Alternatively, the receptacle 9 may have a seal groove surrounding each outlet 8o of the respective root leaching passage 8t, a seal disposed therein instead of in addition to the seal groove and seal 17, and an outlet port for each outlet of the respective root leaching passage.

The supply line 16s may connect the inlet port 9n to an outlet of the pump 12. The feed line 16f may connect the reservoir 13 to an inlet of the pump 12. Each return line 16r may connect one of the outlet ports 90 to the reservoir 13. The reservoir may contain acid 19, such as Aqua regia or a mixture of nitric and hydrofluoric acid. The flowlines 16f,r,s, the pump 12, and the reservoir 13 may be made from or lined with the acid-resistant material.

Alternatively, the acid 19 may be nitric acid, hydrofluoric acid, hydrochloric acid, sulfuric acid, phosphoric acid, perchloric acid, or any mixture thereof.

The power supply 14 may be direct current and have one lead connected to the substrate 3 and one lead submerged in the acid 19 of the reservoir 13, thereby enhancing the leaching process via electrolysis. Whether the positive lead is connected to the substrate 3 and the negative lead is submerged into the acid 19 or vice versa may depend on the type of acid 19 used. The heater/cooler 15c,h may include a heating jacket 15h disposed around the supply line 16s and a cooling jacket 15c disposed around each return line 16r. Heating fluid, such as water, steam, or oil, may be circulated though the heating jacket 15h to heat the acid 19 to a leaching temperature greater than or equal to eighty percent of a boiling point thereof. Coolant, such as water or oil, may be circulated through the cooling jackets 15c to cool the acid 19 to a storage temperature less than or equal to one-half the leaching temperature.

The pump 12 may circulate the acid 19 from the reservoir, through the feed line 16f and supply line 16s, and into the plenum 9p via the inlet port at a flow rate sufficient to maintain a leaching pressure in the plenum. The leaching pressure may range between one point three bars and three hundred bars, between one point three bars and one hundred bars, between two bars and one hundred bars, or between five bars and one hundred bars. The acid 19 in the plenum 9p may enter into the cutting table 5 via the inlets 8e,n and continue along the root 8t and riser 8v passages to the junctions. The acid 19 may continue along the root passages 8t to the outlet 8o and into the return lines 16r via the outlet ports 90. The acid 19 may also leak across an unsealed interface between the cutting table 5 and the shoulder 9s and continue leaking along an unsealed interface between the cutting table and the side of the receptacle 9 to the outlet ports 9o. The acid 19 may flow back to the reservoir 13 via the return lines 16r.

Alternatively, circulation of the acid may be reversed and the inlets 8n,e would then be outlets and the outlet 8o would then be an inlet.

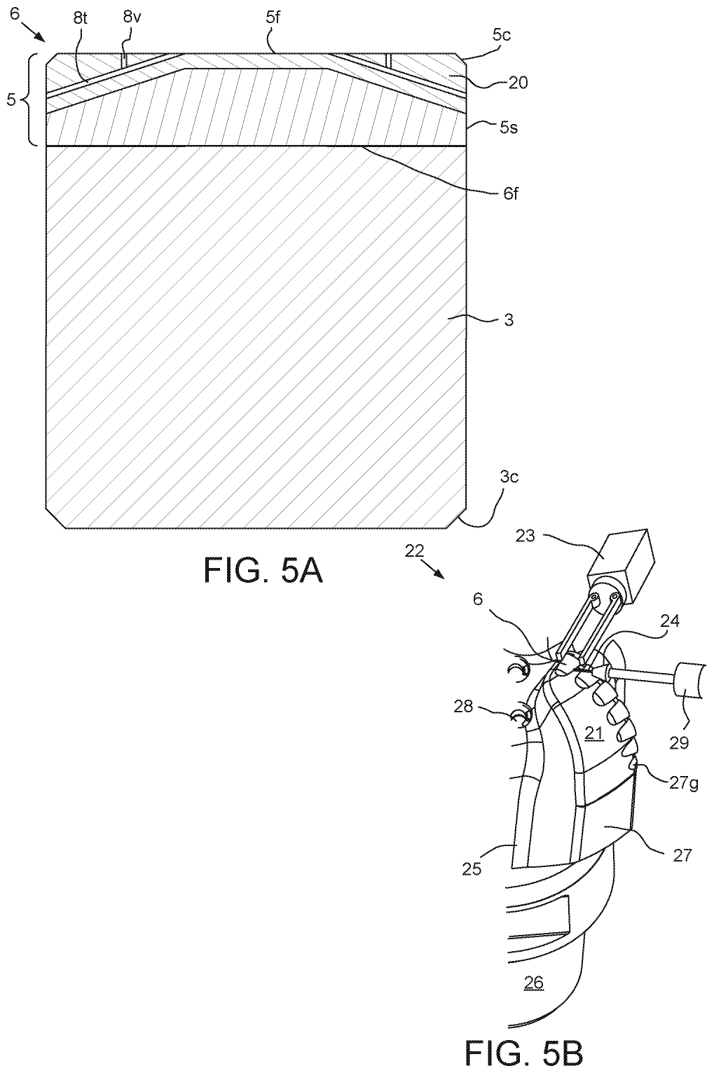

FIG. 5A illustrates the leached superhard cutter 6. The pump 12, heater/cooler 15c,h, and power supply 14 may be operated for a leaching time. Once the cutting table 5 has been leached for the leaching time, the cutter 6 may be removed from the receptacle 9 and transferred to a brazing station. The leaching time may be greater than or equal to one hour, six hours, twelve hours, or one day. Circulation of the acid 19 through the leaching passages 8 may leach at least a substantial portion of the catalyst from a portion of the cutting table 5 adjacent to the front face 5f and side 5s thereof. The acid 19 will also migrate through interstitial spaces in the cutting table 5 to create additional leached regions which will merge with the leached regions attributable to the leaching passages 8. Merging of the leached regions create a thermally stable region 20 including the front face 5f, the chamfer 5c, and a portion of the side 5s adjacent to the chamfer.

FIG. 5B illustrates brazing of the leached cutter 6 into a blade 21 of a drill bit 22. The brazing operation may be manual or automated. A plurality of the cutters 6 may be mounted into pockets formed in a leading edge of the blade 21. Each cutter 6 may be delivered to the pocket by an articulator 23. A brazing material 24 may be applied to an interface formed between the pocket and the cutter 6 using an applicator 29. As the brazing material 24 is being applied to the interface, the articulator 23 may rotate the cutter 6 relative to the pocket to distribute the brazing material throughout the interface. A heater (not shown) may be operated to melt the brazing material 24. Cooling and solidification of the brazing material 24 may mount the cutter 6 to the blade 21. The brazing operation may then be repeated for mounting additional cutters into additional pockets formed along the leading edge of the blade 21. The pocket may be inclined relative to a bottom face of the blade adjacent thereto by a back-rake angle. The back rake angle may range between ten and thirty degrees.

The drill bit 22 may include a bit body 25, a shank 26, a cutting face, and a gage section 27. A lower portion of the bit body 25 adjacent to the cutting face may be made from a composite material, such as a ceramic and/or cermet body powder infiltrated by a metallic binder and an upper portion of the bit body adjacent to the shank 26 may be made from a softer material than the composite material of the upper portion, such as a metal or alloy shoulder powder infiltrated by the metallic binder. The bit body 25 may be mounted to the shank 26 during molding thereof. The shank 26 may be tubular and made from a metal or alloy, such as steel, and have a coupling, such as a threaded pin, formed at a longitudinal end thereof for connection of the drill bit 22 to a drill collar (not shown). The shank 26 may have a flow bore formed therethrough and the flow bore may extend into the bit body 25 to a plenum thereof. The cutting face may form a lower end of the drill bit 22 and the gage section 27 may form an outer portion thereof.

Alternatively, the bit body 25 may be metallic, such as being made from steel, and may be hardfaced. The metallic bit body may be connected to a modified shank by threaded couplings and then secured by a weld or the metallic bit body may be monoblock having an integral body and shank.

The cutting face may include one or more primary blades (not shown), one or more secondary blades 21, fluid courses formed between the blades, and the cutters 6. The cutting face may have one or more sections, such as an inner cone, an outer shoulder, and an intermediate nose between the cone and the shoulder sections. The blades 21 may be disposed around the cutting face and each blade may be formed during molding of the bit body 25 and may protrude from a bottom of the bit body. The primary blades and the secondary blades 21 may be arranged about the cutting face in an alternating fashion. The primary blades may each extend from a center of the cutting face, across (the rest of) the cone and nose sections, along the shoulder section, and to the gage section 27. The secondary blades 21 may each extend from a periphery of the cone section, across the nose section, along the shoulder section, and to the gage section 27. Each blade 21 may extend generally radially across the cone (primary only) and nose sections with a slight spiral curvature and along the shoulder section generally longitudinally with a slight helical curvature. Each blade 21 may be made from the same material as the bit body 25. The cutters 6 may be mounted along leading edges of the blades 21.

One or more ports 28 may be formed in the bit body 25 and each port may extend from the plenum and through the bottom of the bit body to discharge drilling fluid (not shown) along the fluid courses. Once the cutters 6 have been mounted to the respective blades 21, a nozzle (not shown) may be inserted into each port 28 and mounted to the bit body 25, such as by screwing the nozzle therein.

The gage section 27 may define a gage diameter of the drill bit 22. The gage section 27 may include a plurality of gage pads, such as one gage pad for each blade 21, a gage trimmer 27g located adjacent to each gage pad, and junk slots formed between the gage pads. The junk slots may be in fluid communication with the fluid courses formed between the blades 21. The gage pads may be disposed around the gage section 27 and each pad may be formed during molding of the bit body 25 and may protrude from the outer portion of the bit body. Each gage pad may be made from the same material as the bit body 25 and each gage pad may be formed integrally with a respective blade 21. Each gage pad may extend upward from a shoulder portion of the respective blade 21 to an exposed outer surface of the shank 26. Each gage trimmer 27g may be similar to the cutter 6 except for having an outer edge ground to the gage diameter of the drill bit 22.

In use (not shown), the drill bit 22 may be assembled with one or more drill collars, such as by threaded couplings, thereby forming a bottomhole assembly (BHA). The BHA may be connected to a bottom of a pipe string, such as drill pipe or coiled tubing, thereby forming a drill string. The BHA may further include a steering tool, such as a bent sub or rotary steering tool, for drilling a deviated portion of the wellbore. The pipe string may be used to deploy the BHA into the wellbore. The drill bit 22 may be rotated, such as by rotation of the drill string from a rig (not shown) and/or by a drilling motor (not shown) of the BHA, while drilling fluid, such as mud, may be pumped down the drill string. A portion of the weight of the drill string may be set on the drill bit 22. The drilling fluid may be discharged by the nozzles and carry cuttings up an annulus formed between the drill string and the wellbore and/or between the drill string and a casing string and/or liner string.

Advantageously, the leaching passages 8 and circulation of the acid 19 therethrough by the pump 12 is expected to significantly reduce the leaching time for the cutting table 5 compared to the traditional method of simply soaking the cutting table in a bath of acid. Further, it is also expected that a weaker acid may be used to leach the cutting table 5 compared to the traditional method. Both of these benefits are expected to reduce the cost of the leaching process and use of a weaker acid may also reduce risk to personnel conducting the leaching operation.

Alternatively, the acid 19 may be introduced into the leaching passages 8 by soaking the cutting table in a bath of the acid 19 instead of circulating the acid therethrough. Alternatively, the root passage 8t may stop short of reaching the side 5s of the cutting table 5 and the acid 19 may be introduced into the root passage 8t by soaking the cutting head 5 in the bath of the acid.

While the foregoing is directed to embodiments of the present disclosure, other and further embodiments of the disclosure may be devised without departing from the basic scope thereof, and the scope of the invention is determined by the claims that follow.

1. A method for manufacturing a cutter, comprising:
boring a passage into a polycrystalline superhard cutting head, the passage extending from a front face of the cutting head toward a side thereof; and
introducing acid into the passage, thereby removing at least a portion of a metal from the cutting head.

2. The method of claim 1, further comprising forming a chamfer in a periphery of the cutting head at the front face, wherein an end of the passage at the side of the cutting head is behind the chamfer.

3. The method of claim 1, wherein:
the metal is a catalyst,
the method further comprises placing a can into a press, the can comprising superhard powder and the catalyst;
operating the press to sinter the superhard powder, thereby forming the polycrystalline superhard cutting head.

4. The method of claim 3, wherein:
the can comprises the catalyst by loading a substrate into the can, and
the substrate is bonded to the cutting head while operating the press.

5. The method of claim 1, wherein the cutting head is a cutting table.

6. The method of claim 1, further comprising heating the acid to a temperature greater than or equal to eighty percent of a boiling point thereof.

7. The method of claim 1, wherein the passage extends to the side of the cutting head.

8. The method of claim 7, wherein the acid is circulated through the passage.

9. The method of claim 8, wherein:
the cutting head is disposed in a receptacle having a plenum adjacent to the front face,
the acid is circulated at a flow rate sufficient to maintain a pressure in the plenum greater than or equal to 1.3 bars.

10. The method of claim 8, wherein:
the acid is circulated from a reservoir, and
the method further comprises connecting a direct current power supply to the cutting head and the acid in the reservoir.

11. The method of claim 7, wherein:
the passage has an inlet at the front face of the cutting head and an outlet at the side of the cutting head,
the inlet is spaced from the side of the cutting head by a distance ranging between 20% and 40% of a diameter of the cutting head, and
the outlet is spaced from the front face of the cutting head by a distance ranging between 10% and 60% of a thickness of the cutting head.

12. The method of claim 1, wherein:
the passage is a root passage,
the method further comprises boring a riser passage from the front face of the cutting head to the root passage, and
the acid is also introduced into the riser passage.

13. The method of claim 1, wherein a diameter of the passage ranges between 0.01 mm and 1 mm.

14. The method of claim 1, wherein an inclination angle of the passage relative to the front face of the cutting head ranges between 5 degrees and 45 degrees.

15. The method of claim 1, wherein:
at least 8 of the passages are bored into the cutting head, and
the passages are spaced around the cutting head at an increment.

16. A cutter manufactured according to the method of claim 1.
